(19) United States
(12) Patent Application Publication
(10) Pub. No.: US 2014/0240217 A1
(43) Pub. Date: Aug. 28, 2014

(54) SYSTEM COMPRISING AN OCULOMETER, METHOD IMPLEMENTED ON SUCH A SYSTEM AND CORRESPONDING COMPUTER PROGRAM PRODUCT

(71) Applicant: Jean Lorenceau, Paris (FR)

(72) Inventor: Jean Lorenceau, Paris (FR)

(73) Assignees: Centre National de la Recherche Scientifique (CNRS), Paris (FR); UNIVERSITE PIERRE ET MARIE CURIE (PARIS 6), Paris (FR)

(21) Appl. No.: 14/122,412

(22) PCT Filed: May 31, 2012
(86) PCT No.: PCT/EP2012/060309

§ 371 Date: Mar. 3, 2014

(30) Foreign Application Priority Data
Jun. 1, 2011 (FR) 11/01695

(51) Int. Cl. G06F 3/01

(52) U.S. Cl. CPC G06F 3/013
USPC 345/156

(57) ABSTRACT

The invention relates to a system comprising an oculometer for measuring movements of at least one eye of an operator, wherein it comprises furthermore a display for displaying, for the eye, a frame of at least one point performing a blinking, so that the operator can perform at least one smooth tracking movement of the eye while looking at the display while operating. The invention also relates to a method implemented on such a system, and a corresponding computer program product.

### GENERAL TECHNICAL FIELD

The invention relates to a system comprising an oculometer for measuring movements of at least one eye of an operator.

The invention also relates to a method implemented on such a system, and a corresponding computer program product.

### STATE OF THE ART

Systems are known comprising an oculometer for measuring movements of at least one eye of the operator, who has for example lost movement of his upper limbs, for selecting objects offered by a display, for example for written communication.

The objects offered on known displays are for example letters and/or numerals and/or keyboard commands, for example of the kind on a computer keyboard.

The known selection of each object offered is accomplished by a sequence generally comprising:
saccadic movement of the eye, taking as its target the object to be selected, and
fixing the eye on the object to be selected for a predetermined period and/or blinking the eyelids,
   said sequence being measured by the aforementioned oculometer.

The foregoing techniques, however, do have disadvantages.

They allow only the selection of objects offered in a predefined form, and not the generation of objects in the form of a personalized trace. Indeed, psychologically, eye movements consist virtually entirely of saccadic movements between targets (on the order of two to three saccadic movements per second), and cannot therefore be used for generating objects in the form of a personalized trace.

Moreover, they required strong concentration and sustained effort on the part of the operator for controlling the saccadic movements.

Moreover, the aforementioned selection is slow.

Finally, known systems require repeated and very accurate calibration of the oculometer because they use the gaze direction of the eye to designate as a target the object to be selected.

### PRESENTATION OF THE INVENTION

The invention proposes to offset at least one of these disadvantages.

To this end, a system is proposed according to the invention comprising an oculometer for measuring the movements of at least one eye of an operator, characterized in that it also comprises a display for displaying, for the eye, a frame of at least one point performing a blinking, such that the operator is able to carry out at least one smooth tracking movement of the eye while looking at the display while it operates.

The invention is advantageously supplemented by the following features, taken alone or in any technically possible combination:
the display comprises at least one sensor for the coordinates of a projection of the gaze of the eye on the display, and is capable of displaying a reference point in the frame, the position of the reference point depending on the coordinates of the projection of the gaze of the eye onto the display;
the system comprises a unit for processing eye movements of the operator, for generating at least one graphic, and/or at least one letter, and/or at least one numeral, and/or at least one sound, and/or at least one command;
the oculometer is also capable of measuring a diameter of a pupil of the eye of the operator, the unit being capable of modulating the graphic and/or the letter and/or the numeral and/or the sound and/or the command depending on the diameter of the pupil of the eye of the operator;
the system also comprises an interface allowing adjustment of the contrast and/or the blinking frequency of the frame;

The invention also relates to a method implemented on such a system, and a corresponding computer program product.

The invention has numerous advantages.

It allows the operator to carry out smooth tracking movements of the eye.

It allows the generation of objects in the form of a personalized trace, the trace resulting from a smooth tracking movement of the eye of the operator measured by the oculometer. The personalized trace allows the generation
of a graphic and/or
of a letter (or of a string of letters to form a word or a series of words) and/or
of a numeral (or a string of letters to form a numeral) and/or
of a sound and/or
of a command.

The operator is therefore no longer limited to objects having a predefined shape, but can free his creativity and generate objects stamped with his personality (such as for example personal cursive writing and/or a signature), particularly with a view to authenticating the operator.

In addition, it requires relatively little concentration and shorter training time and relies on prior learning, by manual formation of cursive writing for example.

It requires relatively little effort on the part of the operator for eye movements, and a reference point displayed on the display can allow a further augmentation of the control of smooth eye tracking movements, for maximum operator comfort.

Moreover, the generation of objects is quick, for a communication throughput that is also quick.

Finally, the invention requires a less accurate calibration because it uses relative movements of the eye to form the object to be generated, and not the direction of the gaze of the eye to designate as a target the object to be selected as in the prior art.

The invention has numerous fields of application. It is possible to cite, by way of non-limiting examples:
communication, possibly artistic communication, by cursive writing and/or sound by an operator, particularly by an operator having lost movement of his upper limbs (but not eye movement of course);
study and possible correction of eye movements, for example for an operator having visual (age-related macular degeneration (or AMD) for example), cognitive (dyslexia, dyspraxia) or neurological disturbances; or
communication in situation where only at least one eye is available (surgical operation or combat situation for an airplane pilot or infantryman for example).

### PRESENTATION OF THE FIGURES

Other features, objects and advantages of the invention will appear from the description that follows, which is purely illustrative and not limiting, and which must be read with reference to the appended drawings wherein:

FIG. 1 shows schematically a possible embodiment of a system according to the invention,

FIG. 2 shows schematically a possible implementation of a method according to the invention,

FIG. 3 shows schematically the rendering of a frame on a display,

FIGS. 4A and 4B show schematically a blinking of a frame on a display, and

FIGS. 5A, 5B, 5C and 5D show schematically examples of objects generated by a system according to the invention.

In all the figures, similar elements bear identical numerical references.

### DETAILED DESCRIPTION

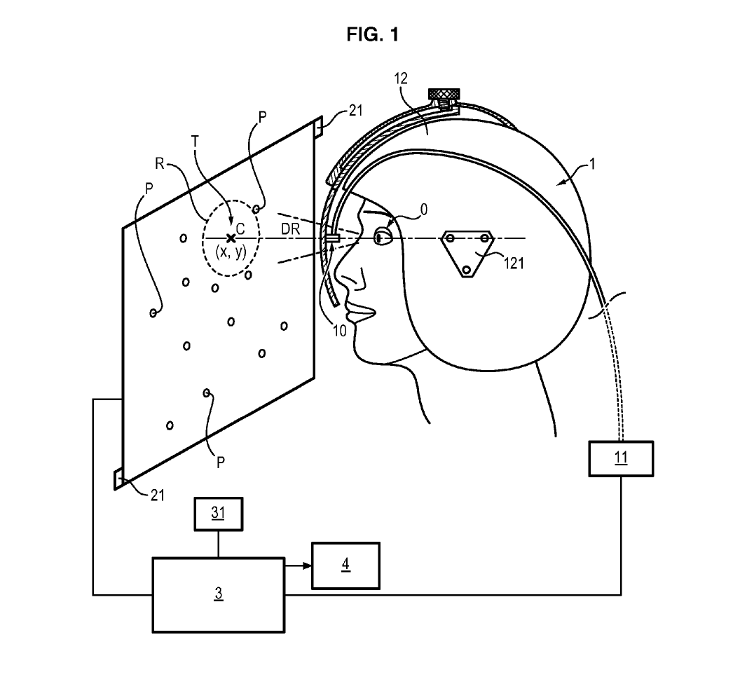

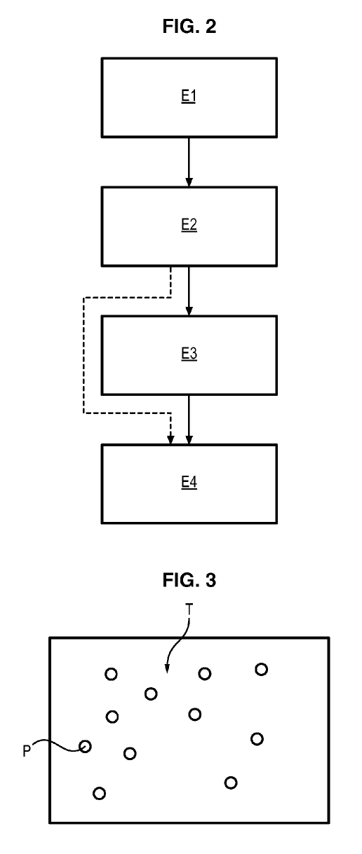

FIG. 1 shows schematically a possible embodiment of a system according to the invention, implementing a possible method shown schematically in FIG. 2.

The system principally comprises an oculometer 1 for measuring, during step E1, movements of at least one eye O of the operator.

The oculometer 1 is a device for measuring eye movements, known to a person skilled in the art and available commercially.

It also comprises at least one camera 10 oriented toward the eye O of the operator for directly observing the eye O and measuring movements of the eye O in an orbit of the operator.

The camera 10 is connected to a processor 11 of the oculometer 1, for recording and processing movements of the eye O of the operator. It is carried on a helmet 12 on the operator.

A non-limiting example of an oculometer 1 which can be used is the Eye-Link II brand oculometer by the company called SR-Research.

As shown by FIGS. 1, 3, 4A and 4B, the system also comprises a display 2 for displaying, for the eye O and during a step E2, a frame T consisting of at least one point P performing blinking.

The frame T is any pattern consisting of at least the point P, visible to the operator. The frame T preferably comprises a plurality of points P.

The points P can for example be distributed at random on the display 2. The points P can be of unequal sizes, and the frame T can have several densities of points P on the display 2.

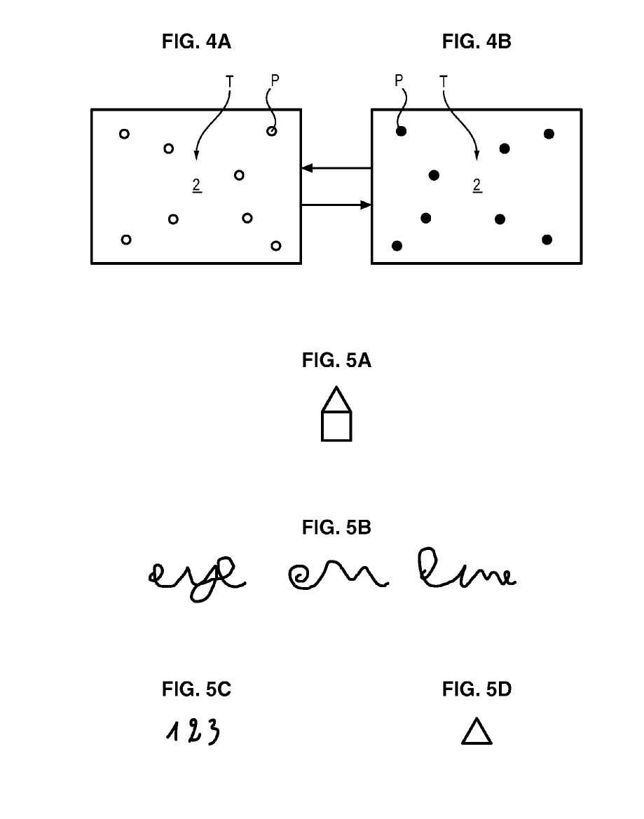

FIGS. 4A and 4B show more precisely that the frame T performs blinking on the display 2, visible to the operator.

Blinking refers to flickering of the frame T, perceptible by the eye O, on the display 2.

The frame T has low contrast compared with a screen background of the display 2, to avoid excessive fatigue of the eye O of the operator.

The screen background can for example be a medium grey color, but any other color can of course be considered.

The blinking is obtained by rhythmic inversion of a shade of the points of the frame T. Thus,
the frame T is displayed with a light shade (for example in white or in a lighter shade of the screen background color of the display 2) for predetermined period of time, by the display 2, as shown in FIG. 4A; then
the frame T is displayed with a dark shade (for example in black or in a darker shade of the screen background color of the display 2) for the same predetermined period of time, by the display 2, as shown in FIG. 4B.

And so on.

The blinking frequency is thus for example comprised between 10 Hz and 40 Hz, preferably comprised between 20 Hz and 30 Hz, with a preferred value at 25 Hz for example.

The display 2 can be a computer or television monitor, or a passive screen whereon the frame T is projected by a projector for example.

The system comprises a processing unit 3 (preferably but without limitation in the form of a computer processor), connected to the monitor or connected to the aforementioned projector, and allowing control of the display of the frame T on the display 2. The processing unit 3 also controls an interface 31 (for example in the form of a graphic control screen of the system, the interface 31 allowing the operator to adjust the contrast and/or the blinking frequency of the frame T.

The operator can carry out at least one smooth tracking movement of the eye O, while looking at the display 2 operating, that is displaying the blinking of the frame T. A smooth tracking movement is a continuous movement of the eye in its orbit, and not a saccadic movement.

In fact, the blinking of the frame constitutes a visual stimulus perceptible by the eye O and allowing such a smooth tracking motion, the latter being impossible in the absence of blinking (only saccadic movements being indeed performed in the absence of blinking). This phenomenon has been observed experimentally, and reference can be made to Sato, T. (1989), Reversed apparent motion with random dot patterns, Vision Research, 29, 1749-1758, or to Spillmann, L. et al. (1997), Reversed visual motion and self-sustaining eye oscillations, Perception, 26(7): 823-30.

Smooth tracking movements of the eye O are continuously measured in real time by the oculometer 1: the processor 11 records and processes the movements of the eye O measured by the camera 10.

As shown by FIG. 1, the processor 11 is connected to the processing unit 3, for example by an Ethernet port when the processing unit 3 consists of a computer processor.

The movements of the eye are interpreted as a trajectory by the unit 3 and recorded in a memory of the processing unit 3. The trajectory is reconstituted as a graphic trace which can be processed by the unit 3.

Processing the movements of the eye O comprises taking into account separation of the trace into different consecutive segments. The separation can be controlled by the computer for example, either by stopping eye movements for a predetermined period or by blinking the eyelids.

As shown by the set of FIGS. 5A through 5D, the unit 3 thus allows, during a step E4, generation, based on the segments of the graphic trace:
of at least one graphic (FIG. 5A), and/or
of at least one letter (FIG. 5B), and/or
of at least one numeral (FIG. 5C), and/or
of at least one sound (not shown in the figures), and/or
of at least one command for a device (FIG. 5D).

The unit 3 can be connected to a device 4, taking into account the generation coming from the unit 3.

The device 4 can be of any type, such as for example a computer comprising
a word and/or drawing processing program and a screen and/or a printer and/or a plotter and/or a memory; and/or
a sound generating program and a speaker; and/or
a home automation program connected to domestic appliances, such as for example blinds, lamps, etc.

The graphic of FIG. 5A can be any graphic, figurative (symbolizing a house here) or abstract, which allows in particular communication of an artistic expression of the operator, by display on the screen and/or on the printer and/or traced on the plotter of the device 4.

As explained above, the words of the expression “eye on line” of FIG. 5B are separated from one another for example by blinking the eyelids, and each word corresponds to a segment of the graphic trace. FIG. 5C shows that it is also possible to generate the number 123 using numerals 1, 2 and 3 separated from one another for example by blinking the eyelids.

The expression of FIG. 5B or the number of FIG. 5A can be displayed on the screen and/or printed on the printer and/or recorded in the memory of the device 4.

In the case where the device 4 is a computer comprising a word and/or drawing processing program, processing by the unit 3 also comprises reduction and/or formatting and/or page layout of the segments of the graphic trace. The smooth tracking movements of the eye O when looking at the display 2 are in fact of considerable magnitude, for greater comfort in moving the eye O, and do not correspond generally to a conventional format such as an A4 format in portrait mode.

The aforementioned processing can also be carried out, entirely or in part, by the device 4.

In the case where the device also comprises a sound generating program and a speaker, the device 4 can also emit a sound that is modulated, in intensity and/or in pitch and/or in timbre for example, depending on the object generated by the movements of the eye O.

In the case where the device comprises in combination the word and/or drawing processing program and the sound generating program and a speaker, the device 4 can also emit a sound corresponding to a letter generated by the movements of the eye O.

Finally, FIG. 5D shows that it is also possible to generate an “upward,” command, for example for raising a blind of a window connected to the device 4.

FIG. 1 shows that the display 2 comprises at least one sensor 21 of the coordinates (x,y) of a projection C of a direction DR of a gaze of the eye O onto the display 2, this measurement of the sensor 21 being performed during a step E3. To this end, the sensor 21 can thus measure the position, particularly of marks 121 on the helmet 12, and use the measurements of the oculometer 1, because the sensor 21 is connected to the unit 3.

The sensor 21 thus allows calibration of the oculometer 1 in relation to the display 2. The calibration, however, can be relatively inaccurate, and therefore can be rapidly carried out during initialization of the system, the calibration not being used for generating objects, the latter using mainly the smooth tracking movements of the eye O.

The display 2 is moreover advantageously designed to display, during step E3, a reference point R in the frame T, the position of the reference point R on the display 2 depending on the coordinates (x,y) of the projection C of the direction DR of the gaze of the eye O into the display 2. Thus the reference point R constitutes a real-time indicator, perceptible by the operator, allowing the latter control of the displacement and of the speed of his eye O.

The reference point R can have any shape, but is very preferably peripheral in relation to the projection C of the direction DR of the gaze of the eye O onto the display 2.

It consists for example of peripheral discs (having for example a diameter comparable to that of the points P) and forming a circular ring centered around the projection C. The crown can have any diameter, but advantageously has between 1/16th and ⅛th of the surface area of the display 2 for example.

The reference point R can be continuously displayed during the operation of the display 2, but can also be blinking.

The reference point R must be perceptible to the eye, and has consequently more contrast than the frame T relative to the screen background of the display 2.

The shape, the size and the contrast of the reference point can be adjusted by the operator via the system interface 31.

According to one advantageous variation, the oculometer 1 is designed to also measure a diameter of the pupil of the eye O of the operator, the unit 3 is designed to modulate the graphic and/or the letter and/or the numeral and/or the sound and/or the command according to the diameter of the pupil of the eye O of the operator.

The thickness of the stroke of the trace can also increase when the diameter of the pupil increases, to increase the expressivity of writing, because the diameter of the pupil of the eye manifests the emotions of the operator.

It is understood that
all or part of the processor 11 can be included in the unit 3, and conversely, and/or
all or part of the device 4 can also be included in the unit 3, and conversely, and/or
all or part of the interface 31 can be included in the display 2, and conversely.

The invention also relates to a computer program product comprising instructions which, once loaded into a memory of a computer, allow the implementation of a method according to the invention. The product can be on any computer medium, such as for example memory or a CD-ROM.

1. A system comprising an oculometer for measuring movements of at least one eye of the operator,
wherein it also comprises a display for displaying, for the eye, a frame of at least one point performing a blinking, so that the operator can carry out at least one smooth tracking motion of the eye while looking at the display in operation.

2. The system according to claim 1, wherein the display
comprises at least one sensor of coordinates of a projection of a direction of a gaze of the eye onto the display, and
is designed to display a reference point in the frame, the position of the reference point on the display depending on the coordinates of the projection of the direction of the gaze of the eye into the display.

3. The system according to claim 1, comprising a unit for processing the movements of the eye of the operator, for generating:
at least one graphic, and/or
at least one letter, and/or
at least one numeral, and/or
at least one sound, and/or
at least one command.

4. The system according to claim 3, wherein the oculometer is designed to also measure a diameter of the pupil of the eye of the operator, the unit being designed to modulate the graphic and/or the letter and/or the numeral and/or the sound and/or the command depending on the diameter of the pupil of the eye of the operator.

5. The system according to claim 1, also comprising an interface allowing adjustment of the contrast and/or the blinking frequency of the frame.

6. A method comprising a step in which an oculometer measures movements of at least one eye of the operator,
wherein it also comprises a step wherein a display displays, for the eye, a frame of at least one point performing blinking, such that the operator can carry out at least one smooth tracking motion of the eye while looking at the display in operation.

7. The method according to claim 6, comprising a step wherein at least one sensor of the display measures coordinates of a projection of a direction of a gaze of the eye onto the display,
and wherein the display displays a reference point in the frame, the position of the reference point on the display depending on the coordinates of the projection of the direction of the gaze of the eye onto the display.

8. The method according to claim 6, comprising a step wherein a unit for processing movements of the eye of the operator generates:
at least one graphic, and/or
at least one letter, and/or
at least one sound, and/or
at least one command.

9. The method according to claim 8, comprising a step wherein the oculometer also measures a diameter of a pupil of the eye of the operator, and wherein the unit modulates the graphic and/or the letter, and/or the sound and/or the command depending on the diameter of the pupil of the eye of the operator.

10. A computer program product comprising instructions which, once loaded into a memory of a computer, allow the implementation of a method according to claim 6.
